(19) United States
(12) Patent Application Publication
(10) Pub. No.: US 2007/0110639 A1
(43) Pub. Date: May 17, 2007

(54) System and method for positioning and synthesizing of nanostructures

(75) Inventors: Sanjay Joshi, Port Matilda, PA (US); Stephen J. Fonash, State College, PA (US); Wook Jun Nam, State College, PA (US); Pranav Garg, State College, PA (US)

Correspondence Address: NIXON PEABODY, LLP, 401 9TH STREET, NW, SUITE 900, WASHINGTON, DC, 20004-2128, US

(73) Assignee: Pennsylvania State University, University Park, PA (US)

(21) Appl. No.: 11/581,080

(22) Filed: Oct. 16, 2006

Related U.S. Application Data
(60) Provisional application No. 60/726,224, filed on Oct. 14, 2005.

(51) Int. Cl. B01J 19/00

(52) U.S. Cl. 422/130

(57) ABSTRACT

The invention relates to a method of forming at least one nano-structure with a reusable template structure having a channel. The method includes introducing at least one reagent into the channel, and reacting the at least one reagent to form a nano-structure within the channel. The nano-structure forming channel may be positioned in alignment with one or more electrode structures, which may be positioned within or upon the substrate, may be embedded in the reusable template structure, and/or may be external electrode structures positioned outside of the reusable template structure and independent of the substrate. In addition, the electrode structures may be a source material for the formation of the nano-structure in the channel.

### RELATED APPLICATION DATA

This application claims priority to U.S. Provisional Patent Application 60/726,224, filed Oct. 14, 2005, which is hereby incorporated by reference in its entirety.

### FIELD OF THE INVENTION

This invention relates to methods for forming nano-structures using reusable template structures. In addition, this invention relates to methods of positioning and forming nano-structures through the use of electrodes, including consumable electrodes.

### BACKGROUND OF THE INVENTION

Nano-structures or nanoelements such as nanowires, nanoribbons, nanotubes, nanocolloids, nanotetrapods, nanodiscs, nanorods, nanobeads, and the like, attract a great deal of attention because of their huge potential in a wide range of applications from chemical/biological sensors to quantum electronic devices. The small size of these structures provides advantages ranging from enhanced integration in device fabrication to high detection sensitivity in sensor applications. However, many of these advantages are only possible if the position of the nano-structure is precisely controlled. For this reason the development of techniques for nano-structure positioning is extremely important.

The future success of nanotechnology lies in the ability to manufacture in large volumes in an economical and environmentally sound manner. This is central to the evolution and pervasive application of nanotechnology. Over the past several years considerable progress has been made in the synthesis of bulk nano powders, tubes, wires, rods, and fibers, among other geometries. However, progress is only truly achieved when these building blocks are assembled into useful systems. Many approaches have been proposed to achieve this objective. Often these are based on using direct pick and place [1], microfluidic assisted alignment [2], or electric field induced alignment [3] assembly. However, such techniques are not practical and usually time consuming. In addition, the techniques are not environmentally safe since only few out of a large number of grown nanostructures are used for the assembly and the unused nanostructures are discarded.

Several approaches have been explored for fine positioning control of nano-structures. Most of these techniques are also not practical or not controllable, or both. Among them, Park, et al. used an organic linker (single stranded deoxyribonucleic acid (ssDNA)) to locate gold nanocolloids between two electrodes. (See S.-J. Park, T. A. Taton, and C. A. Mirkin, Science, 295, 1503-1506 (2002)). However, this method does not provide a high density of assembled nanocolloids because of the repulsive force caused by electrical charges. Prevo, et al. introduced a method using an evaporation of a nanostructured suspended solution. (See B. G. Prevo and O. D. Velev, Langmuir, 20, 2099-2107 (2004)). This approach only works for a layer and does not provide any controllable nanostructure positioning at a selected location. Cui, et al. improved this technique using an e-beam lithography defined nano-scale structure. (See Y. Cui, M. T. Björk, J. A. Liddle, C. Sönnichsen, B. Boussert, and P. Alivisatos, Nano Lett., 4(6), 1093-1098 (2004)). However, their method is not practical since it requires repeated use of e-beam lithography and the nano-structure positioning process is slow. Techniques using an electrophoresis and/or a dielectrophoresis have also been introduced for the control of nano-structure positioning. Bhatt, et al. used dielectrophoresis using two electrode structures positioned in a 0.1 mm high channel structure. (See K. H. Bhatt and O. D. Velev, Langmuir, 20, 467-476 (2004)). In this approach, the direction of the nano-structure positioning is random and the positioned structure has a significant, unwanted branching structure. Docoslis, et al. also tried to confine nano-structures between two electrodes using dielectrophoresis, but the method only appears to work in the hundreds of micro meter range. (See A. Docoslis and P. Alexandridis, Electrophoresis, 23, 2174-2183 (2002)).

Accordingly, there is a need for nanoscale manufacturing processes which can be done in large volumes as well as in an economical and environmentally sound manner. The invention answers that need by providing novel nano-structure positioning methods using unique approaches to form positioned nano-structures. These methods include the use of (1) reusable template structures and (2) electrodes, including consumable electrodes. The methods of the invention provide better control in nano-structure positioning than existing techniques in the art, and also are suitable for high throughput processing. The methods also allow the use of mixed nano-structures thereby providing more options in practical array or device fabrication.

### SUMMARY OF THE INVENTION

In one embodiment, the invention relates to a method of forming at least one nano-structure. The method includes a step of positioning a reusable template structure on a substrate, the reusable template structure including at least one nano-structure forming channel. The method further includes introducing at least one reagent including an electrolyte into the channel, and reacting to form a nano-structure within the channel.

The nano-structure forming channel may be positioned in alignment with at least one electrode structure. As will be described herein, the configurations of the electrode structures may vary. For example, in one configuration, at least one of the electrode structures may be positioned within or upon the substrate. In another configuration, at least one of the electrode structures may be embedded in the reusable template structure. In a third configuration, at least one of the electrode structures may be an external electrode structure positioned outside of the reusable template structure and independent of the substrate. In addition, at least one of the electrode structures may provide a source material for the formation of the nano-structure in the channel.

### BRIEF DESCRIPTION OF THE DRAWINGS

FIGS. 1A-1C illustrate an exemplary method of the invention related to forming a nano-structure with a reusable template structure and a pair of electrode structures positioned within a substrate.

FIGS. 2A-2B illustrate exemplary alternative electrode configurations including electrode structures positioned within the substrate and embedded in the reusable template structure.

FIGS. 3A-3B illustrate exemplary alternative electrode configurations including electrode structures positioned within the substrate, embedded in the reusable template structure, and positioned externally relative to the reusable template structure and the substrate.

FIGS. 4A-4D illustrate an exemplary method of the invention related to forming a nano-structure with the use of catalyst and a reusable template structure.

FIGS. 5A-5D illustrate a gold nanobead wire structure after a reusable template structure was removed.

FIGS. 6A-6B show a polyaniline wire formed in accordance with the invention.

FIGS. 7A-7D show nanowires grown using external electrode structures.

### DETAILED DESCRIPTION OF THE INVENTION

This invention relates generally to methods of forming nano-structures in predetermined locations on a substrate. Reusable template structures are used for the growth and positioning of nano-structures. Nano-structures, as used herein, can refer to, for example, nanoelements, nanoparticles, nano-beads, nanocolloids, nanotetrapods, nanodiscs, nanowires, nanoribbons, nanorods, and any other structure that has at least one dimension in the nanoscale regime.

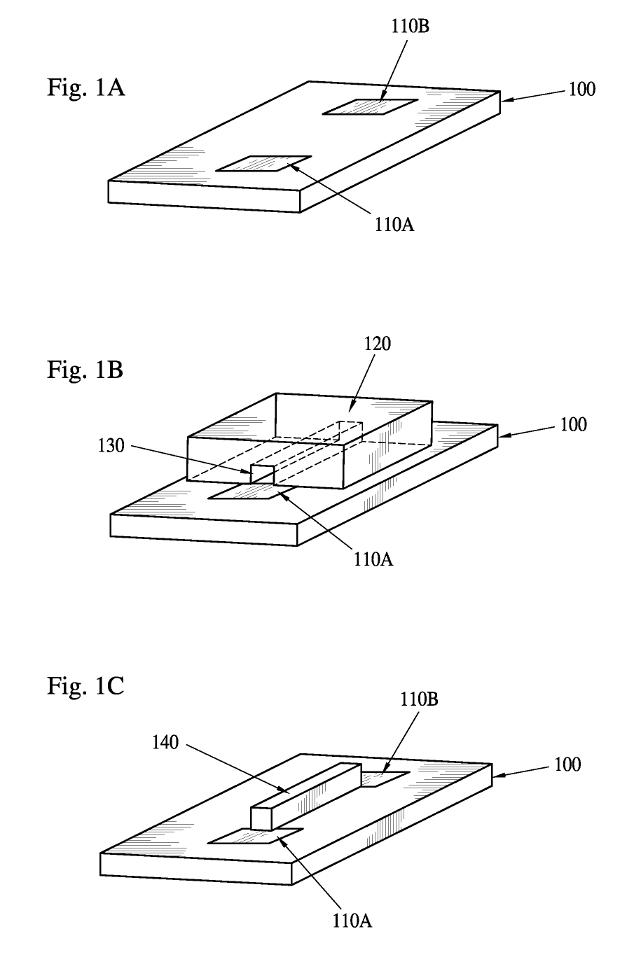

As is shown in FIGS. 1-3, a method of the invention relates to forming at least one nano-structure through the use of a reusable template structure. A “reusable template structure,” is a template that is capable of being re-used two or more, preferably multiple, times. The reusable template structure preferably includes a nano-structure forming channel in which the nano-structures may be formed. The channel may be any shape or pattern including, for example, straight, curved, spiral, crossed lines or curves, and the like. This type of nano-structure positioning and nano-structure development will be referred to as the “step-and-grow” methodology. Generally, this methodology includes a step of positioning the reusable template structure, growing/positioning the nano-structures, and removing the reusable template structure. This methodology can include the use of reagents which is used herein to also include electrolytes.

Because the reusable template structure has an open nano-structure forming channel (e.g., no bottom to the nanochannel), the reusable template structure is reusable and hence movable from position to position since the substrate upon which the nano-structure is fabricated serves as a supporting structure. In this manner, the reusable template structure may be stepped (i.e. moved) from one position on the substrate to another position on the same substrate or another substrate entirely. This stepping may include any type of re-positional movement, including, for example, lateral movement across the substrate, vertical movement above the surface of the substrate, rotational movement relative to the substrate, or any combination thereof. By way of an exemplary orientation, the substrate may serve as the floor (i.e., bottom) of the nano-structure forming channel. Templates may be applied in multiple steps to form structures one upon another.

Since the reusable template structure can be positioned with precision using an approach such as that used in “step-and-flash” lithography, any electrode structures, if needed, need not be built only into the template but may instead reside on the substrate. Alignment of a template may be accomplished by aligning a feature in or on the template with respect to the substrate or a feature in or on the substrate. Such alignment may be accomplished by aligning a feature in or on the template with respect to an electrode in or on the substrate. Both the reusable template structure and/or the substrate may contain one or more electrode structures. In addition, it should be noted that the reusable template structures and the substrates of the invention may include any number of electrode structures, with certain electrode structures being activated, as needed, for the formation of the desired nano-structures.

The electrode structures used herein may be positioned, placed, or formed in or around the reusable template structure and substrate using any techniques known in the art. The electrode structures can be formed on or in the reusable template structure or on the substrate using any method known in the art including, for example, the use of electrode pattern definition, electrode material deposition, and removal of the electrode material deposited on unwanted area.

One preferred method for forming an electrode structure, such as a consumable electrode structure, is to start a deposition of the electrode structure. The layer can be deposited on the substrate using any means known in the art (e.g. physical vapor deposition, chemical vapor deposition, electrochemical deposition, and spin on coating). Next, the shape of the consumable electrode structure is defined using a pattern generation techniques (e,g, e-beam lithography and nano-imprinting lithography) on a resist layer. The electrode structure is finally formed after removing the layer deposited on unwanted area (i.e. the area which is not protected by the resist layer) using material removal processing (e.g. dry etching and wet chemical etching).

Another preferred method is to define the electrode pattern as described above on a resist layer. After the pattern is defined, a layer for the electrode structure is deposited using the deposition techniques mentioned above. The layer deposited on unwanted area is then removed during the following lift-off process.

In addition, the electrode structures may be any suitable material known in the art (organic and/or inorganic). For example, any combination of metals (e.g., nickel, chromium, and tin) may be used. Furthermore, the electrode structures may be a high surface area to volume ratio material formed by conventional processes as known in the art. Also, the high surface area to volume ratio material may be formed as described in U.S. Patent Application Publications Nos. 20020020053, 20030157783, and 20040005258, which are hereby incorporated by reference as if fully set forth herein. In addition, the electrode structures of the invention may be a source material for the formation of the nano-structure in the channel of the reusable template structure. This type of electrode, which may also be referred to a consumable electrode, is an electrode structure that is used chemically as a reactant to create the nano-structure, and is consumed during the process. Example 3 describes use of a consumable external electrode structure made of tin.

The aforementioned “step-and-flash” lithography is known to one of skill in the art. By way of example, it is described in “Development of Imprint Materials for the Step and Flash Imprint Lithography Process”, Xu, et al., SPIE Microlithography Conference, (2004), which is hereby incorporated by reference as if fully set forth herein. The substrate upon which the nano-structure is formed may be a blank substrate or one which has other existing structures previously formed upon or in it. The reusable template structure may also include access ports to allow entry of liquids, gases, reagents, and liquid suspensions bearing nanoelements or reagents.

The reusable template structure can be fabricated from various materials (e.g., metals, semiconductors, insulators, polymers, organics, and combinations thereof), and the materials used can be decided in view of the intended application of the template. For example, Example 1 describes the formation of a reusable template structure formed of polydimethylsiloxane (PDMS). As mentioned above, the reusable template structure may also contain one or more electrode structures. The electrode structures may also be positioned on or in the substrate, or may be positioned external to both the template and substrate. Thus, the electrode structure may be positioned in one or more of the following positions: within the reusable template structure, on or in the substrate, external to both the reusable template structure and the substrate, or combinations thereof.

As is stated above, if an external electrode structure is used, the position of the external electrode structure is independent from the reusable template structure and the substrate. Thus, the control of the external electrode position is also independent. Generally, the position of the external electrode structure can be controlled by tuning a manipulator of the needle, and the manipulator can control the position of the needle in x, y, z direction precisely. Thus, when an external electrode structure is used, the reusable template structure is positioned, an electrolyte solution is applied, the substrate and reusable template structure stack is positioned under an optical microscope in an I-V station, and needles are used to position the external electrode structures relative to the substrate and the solution using the manipulator.

The channel pattern may be designed to fit the needs of the overall device being manufactured. For example, in some instances, this may be a straight channel to position a nanowire within the device. Alternatively, as another example, the reusable template may have a plurality of channels in the pattern of a circuit or other feature to be introduced. The shape of the channel itself may be designed depending on its use. For example, the channel may have a square, a rectangular, a triangular, or other geometric or varying cross-section shapes. The channel may also be curved or rounded.

It should be noted that the nano-structures of the invention may be fabricated on any type of substrate known in the art, for example, semiconductive, plastic, glass, metallic, and the like. The growth and synthesis techniques of the nano-structures may include chemical processes and reactions. For example, reagents used to form these nano-structures may be delivered in a solid, liquid, or vapor phase, in a solution, or in a suspension. The reagents may then be reacted into a nano-structure within one or more channels in a reusable template structure.

The use of the reusable template structure of the invention has distinct advantages over the traditional use of a permanent template that is etched in place and then removed after the nano-structures are formed. For example, the “step-and-grow” technique of the invention using the reusable template structures of the invention eliminates the need for repeated building of permanent templates, reduce the inefficiencies created by a long process chain, is applicable to a wide range of materials, and enable the ability to build similar nano-structures in large arrays of structures of dissimilar materials and disconnected regions with improved efficiency. In addition, the use of a reusable template structure reduces unnecessary processing steps such as a resist development process for e-beam lithography or focused ion beam lithography and residue descuming for e-beam lithography, focused ion beam lithography, and nano imprinting lithography. Example 1 describes the formation of an exemplary reusable template structure.

Referring now to FIGS. 1A-1C, reusable template structure 120 preferably includes at least one nano-structure forming channel 130 positioned by aligning with at least one of electrode structures 110A and 110B located on the substrate. The channel, shown here as a straight line, may be formed in any desired shape, including, for example, a straight line, a curved line, any geometric shape, a circular or spiral design, a plurality of straight or curved lines, and the like. During operation, reusable template structure 120 is positioned in a predetermined location on substrate 100. Because of the steppable characteristics of the reusable template structure, the reusable template structure may be moved or repositioned to another location on the substrate, as required.

Preferably, nano-structure forming channel 130 of reusable template structure 120 is positioned in alignment with at least one of electrode structures 110A and 110B, which may be arranged in a variety of configurations. For example, in the configuration shown in FIGS. 1A-1C, the two electrode structures 110A and 110B may be electrode pads positioned within substrate 100. In this configuration, the electrode pads are set into the surface of the substrate such that the top surface of each electrode pad is substantially aligned with the top surface of the substrate, and the electrode pads to not include any significant raised portion. Another characteristic of FIGS. 1A-1C is that neither of the electrode structures are positioned within the reusable template structure. Instead, the electrode structures are positioned on the substrate. In general, any electrode structures located in or on the substrate, such as those shown in FIGS. 1A-1C, can also be used as electrical contacts for the future operation in electronic devices and/or sensor devices.

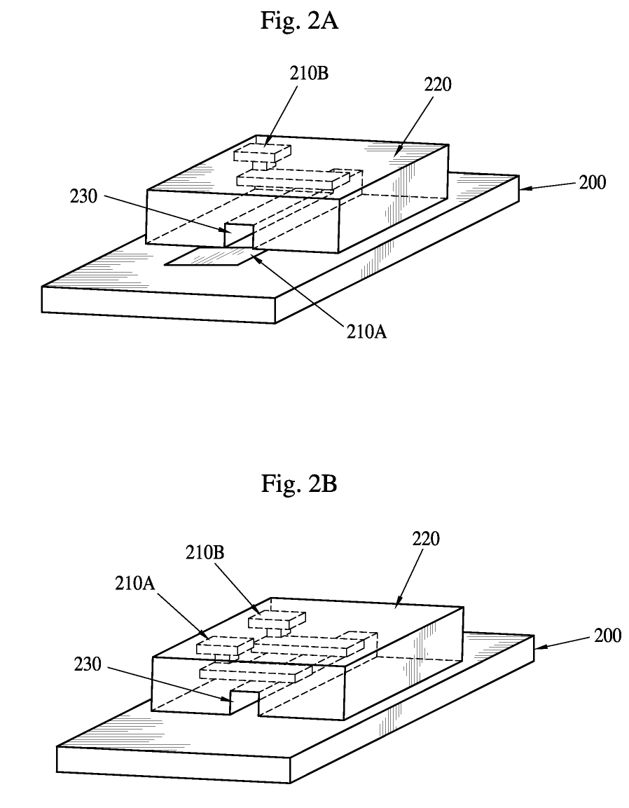

In an alternative configuration shown in FIG. 2A, an electrode structure 210A is positioned within or upon the substrate 200. In addition, FIG. 2A illustrates the use of an electrode structure 210B that is embedded within reusable template structure 220. Reusable template structure 220 again includes a channel 230. Reusable template structure 220 may be aligned with electrode structures 210A located on the substrate. FIG. 2B illustrates another configuration in which electrode structures 210A and 210B are both embedded within reusable template structure 220. By positioning embedded electrode structures within the reusable template structure, it is possible to form a nano-structure 240 on substrate 200 that extends along the surface of substrate 200 without requiring the existence of any electrodes on the substrate. Reusable template structure 220 may be aligned, for example, with an alignment feature located on the substrate, if necessary.

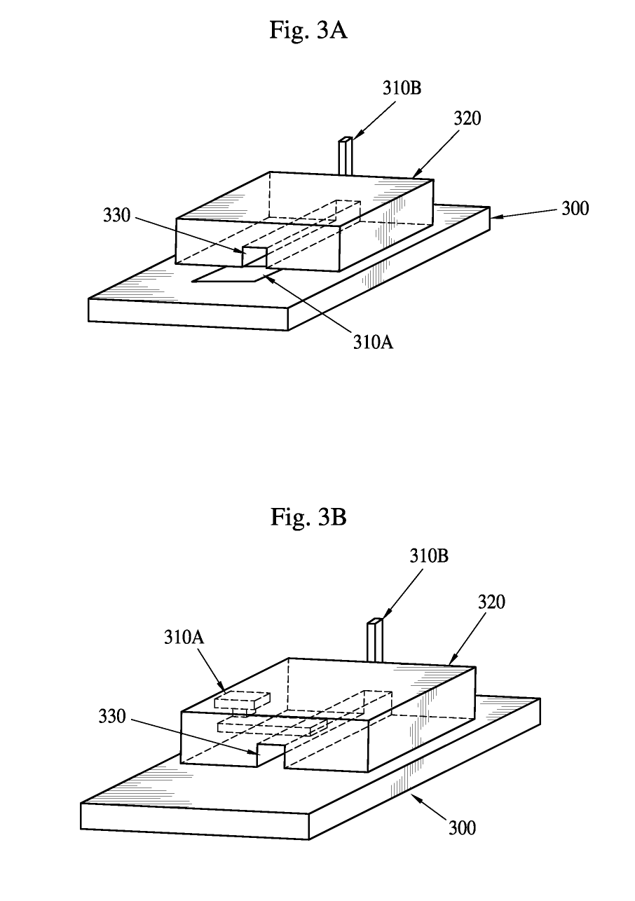

In a further alternative configuration shown in FIGS. 3A-3B, an external electrode 310B is used in combination with a second electrode structure. External electrode 310B is an electrode structure located in a position external to both reusable template structure 320 and substrate 300. Reusable template structure 320 again includes a channel 330. In FIG. 3A, the other electrode structure 310A is positioned within or upon substrate 300. Thus, FIG. 3A illustrates an arrangement in which the reusable template structure is not required to include any electrode structures. Instead, the electrode structures are positioned on the substrate and external to both the substrate and the reusable template structure. In FIG. 3B, the other electrode structure 310A is embedded within reusable template structure 320. Reusable template structure 320 may be aligned using the electrode on the substrate in FIG. 3A, for example. Reusable template structure 320 may be aligned using, for example, a feature on the substrate in FIG. 3B, for example, if necessary.

Referring again to FIGS. 1A-1C, after reusable template structure 120 is properly aligned, reusable template structure 120 is pressed against the surface of substrate 100 with nano-structure forming channel 130 facing the surface of substrate 100. The nano-structure is formed within this channel. As indicated above, the channel may be designed to create any size or shape of nano-structure, including, for example, and geometric shape or plurality of geometric shapes. In addition, while the embodiment illustrated in FIG. 1 shows reusable template structure 120 being pressed against the surface of substrate 100, reusable template structure 120 may also be positioned against other existing structures on or near substrate 100. For example, if other nanoelements or nano-structures are already present on substrate 100, reusable template structure 120 may be positioned adjacent to, or above those nanoelements or nano-structures, and the new nano-structures may be formed in any position relative to the existing nanoelements and nano-structures, thereby creating a stacked or other configuration of nanoelements and nano-structures, including, for example, a crisscrossed configuration. In addition, if the surface of the substrate is not a smooth surface, and includes, for example, topographical features, the reusable template structure may be positioned in any position or orientation relative to those features of the substrate, and the new nano-structures may be formed accordingly.

After reusable template structure 120 is properly positioned against substrate 100, at least one reagent is introduced into channel 130 on reusable template structure 120. Examples of different types of suitable reagents include, but are not limited to monomers, organics, metal catalysts, salts, and electrolytes. Specific examples of suitable reagents include aniline monomers, norbornene monomers, acetylene, silane (SiH₄), metal salts, and the like. Any type of reagents may be introduced into the channel of the reusable template structure that is suitable for formation of nano-structures.

In the case of the aniline monomers, which is a reagent compatible with FIGS. 1-3, a solution including the aniline monomers is introduced into channel 130. After a sufficient amount of the aniline monomer is present in channel 130, the aniline monomer is reacted to form nano-structure 140 within channel 130. If the reagent used is a aniline monomer or a similar reagent, the reacting step may include electropolymerization or any other known process. Example 2 describes the formation of an exemplary nano-structure formed by electropolymerization.

In the specific situation of electropolymerization, an electric field is created inside a channel after a reusable template structure is positioned between the electrode structures and a monomer is introduced in the channel structure. A nano-structure is then synthesized electrochemically, and after the synthesis process is finished, the reusable template structure may be moved, if necessary, to its next position for the next electropolymerization. The electrodes in these cases can be already positioned on the substrate (as described above), can be built into the template, can be external to both the reusable template structure and the substrate, or can be some combination of the above.

If a reagent such as silane (SiH₄) is used, the method may further include a step of introducing a catalyst into the channel using the electrodes prior to the step of introducing at least one reagent. The catalyst may be any suitable catalyst, including, for example, a liquid or vapor catalyst source, or a nanoparticle catalyst source, such as a nanocolloid. If the catalyst is a liquid or vapor phase catalyst source, it is preferably applied to form a layer inside of the channel wall. Examples of catalyst source are described in U.S. Patent Application Publication No. 20040005258, which is hereby incorporated by reference.

As described above, the catalyst may also be a nanocolloid, or a plurality of nanocolloids, such as gold or titanium nanocolloids. Suitable nanocolloids include, for example, gold colloids, silver colloids, and others known in the art. Different nanocolloids can be positioned in the template structure by, for example, dielectrophoretic forces. If different sizes of nanocolloids are introduced, it is preferred that larger nanocolloids be positioned first, followed by the smaller nanocolloids. In addition, the nanocolloids may be any mixture of types, sizes and shapes of nanoelements. The nanocolloids can be of any suitable size, for example, having a diameter of about 1 nm to 100 μm.

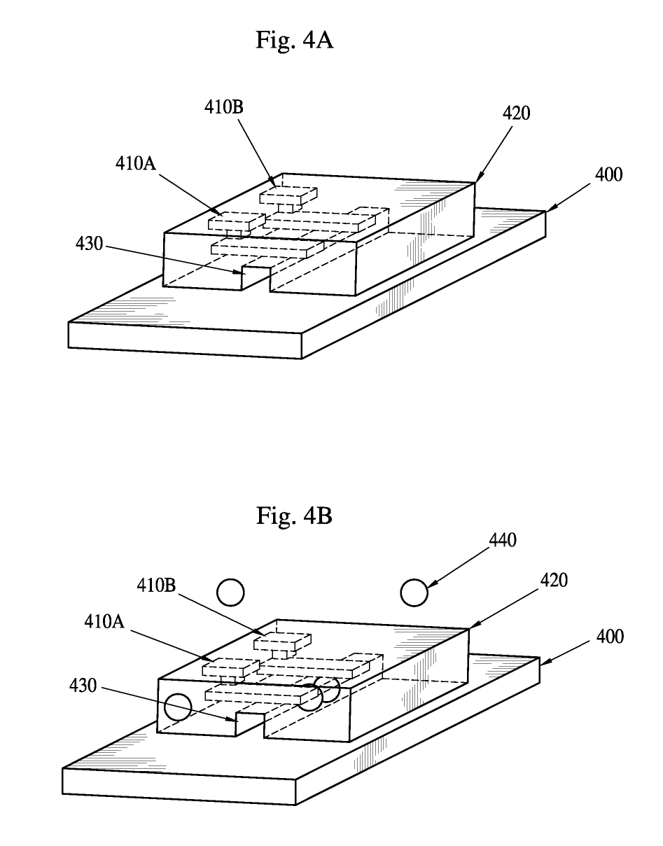

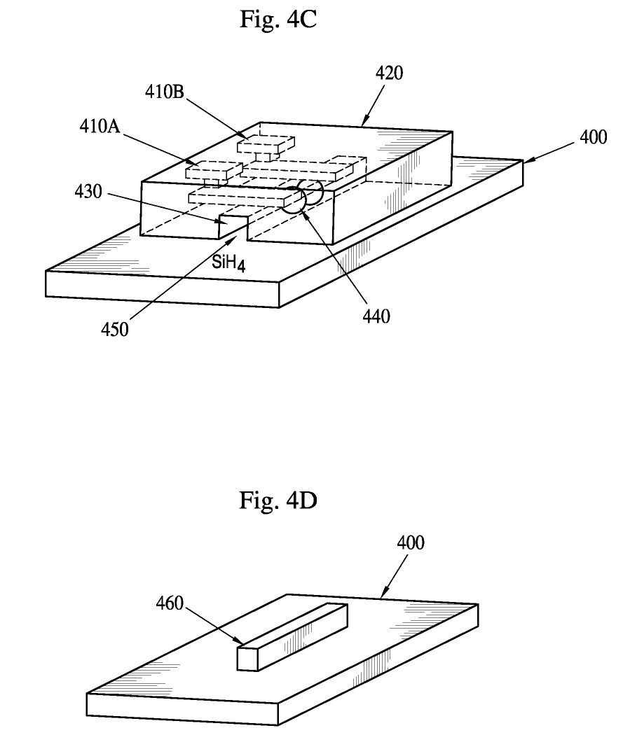

FIGS. 4A-4D illustrates a method of the invention in which a template structure 420 including embedded electrode structures is positioned against a substrate 400. In this example, a catalyst 440 is introduced into a channel 430 by using electric fields in template structure 420. After the catalyst particles are positioned within channel 430, the reagent is introduced, in this example, SiH₄, and nano-structure 460 is formed within channel 430 by any means known in the art, including, for example, low-pressure chemical vapor deposition (LPCVD). Finally, after nano-structure 460 is formed, template structure 420 may be removed from the substrate, leaving nano-structure 460 positioned on substrate 400 between electrode structures 410A and 410B.

The placement of the catalyst and other nanoelement particles within the channel of a template structure of the invention may also be achieved or augmented using some combination of traditional placement methods including, but not limited to, capillary action, sonication, electro-static, and electromagnetic forces. In addition, it is preferred that a liquid suspension of the particles be introduced to the channel for placement. When capillary action is used for positioning, the capillary force inside the nano-structured device draws the nanoelements in the liquid suspension into the nano-channel through one or more access ports. Sonication may be used in combination with capillary or electromagnetic positioning to aid in moving the nanoelements.

When magnetic or electric fields are used for positioning, their effectiveness depends on the magnetic properties or the charge or dipoles present in the nanoelements being positioned. One electro-static or electromagnetic approach for using a liquid suspension to carry nanoelements of the liquid suspension into a channel of a template is to use electric field effects such as electrophoresis and dielectrophoresis. Such fields can be time varying, as needed.

For the dielectrophoretic process, a nonuniform electric field is applied to the liquid suspension of nanoelements using external electrodes in the liquid suspension at different ports, or using an external electrode or electrodes positioned in the liquid suspension in combination with one or more embedded electrodes in a reusable template structure. The spatially non-uniform electric field causes the nanoelements to become polarized and experience a net force (dielectrophoretic force). Under the proper electric field conditions, nanoelements can be moved to locations in the channel or channel-bearing reusable template structure.

As mentioned above, the methods of the invention may employ a liquid suspension of nanoelements for introduction and positioning of nanoelements. For example, nanoelements may be suspended in water, purified water, deionized water, distilled water, and the like. Also, the liquid suspension may include a volatile organic solvent, a mixture of solvents, an aqueous mixture of water and one or more organic solvents or mixtures of organic solvents. The organic solvents may be common organic solvents as known in the art and/or may be polar or non-polar solvents. For example, the solvents may include methanol, ethanol, acetone, tetramethylfluoride (TMF), isopropyl alcohol, and the like. The pH of the liquid suspension may also be adjusted as is known in the art. The suspensions may also include surfactants, dispersants, and other common additives.

As is indicated above through the use of nanocolloid catalysts, nanoelements do not need to fill in the entire channel in a template structure for some applications. Such a situation can be used for a semiconductor nanowire growth using the vapor-liquid-solid (VLS) technique. In this case, a nanoelement or other structure may be used as a catalyst “slug” for a VLS application. In particular, catalyst nanoelements may be positioned in the channel instead of using traditional methods of etching a catalyst to create the catalyst slug needed for VLS nanowire growth. Thus, the amount of catalyst and its position can be controlled resulting in controlled VLS growth.

In cases where the positioned nano-structures are to be electrically connected, another pattern definition process may take place to define these permanent contacts (i.e. permanent electrodes). These may be augmented to any degree by retaining any growth/positioning contacts originally on or in the substrate. Such permanent contacts may be made, for example, by a metal deposition and lift-off process to form embedded electrode structures. Conventional or nanolithography techniques may be used for the permanent electrode pattern definitions.

### EXAMPLES

### Example 1

### Formation of a Nanoparticle Ensemble Using a Reusable Template Structure

As a demonstration of the temporary-template approach to positioning nano-structures, a single-layered polydimethylsiloxane (PDMS) reusable template structure without an electrode structure was prepared. Even though it is desirable to use the double PDMS layers, a single PDMS layer was used for the specific example since the single layer worked fine in the scale of larger than 10 um. A pattern of the template structure was defined on a gold film coated silicon wafer (the master) using standard lithography to create a mold to make a PDMS reusable template structure which had no template floor for the channels. The reusable template structure features found on the master were produced using etching. The feature dimensions were 25 μm in width, 20 μm in height, and 2 cm in length. A PDMS solution was used for casting the reusable template structure.

When PDMS is used, the reusable template structure may include a single or double layer of PDMS. Preferably, a double layer of PDMS is used for narrow channel structures (e.g., less than 1 μm). For a single layer PDMS, a PDMS solution can be mixed which includes a curing agent, preferably, Dow Corning's Sylgard 184 PDMS. Next, the PDMS solution was placed on the master mold and cured, for example, in a vacuum at 60° C. for about an hour or under ambient conditions for about 12 hours. For a double layer PDMS, a PDMS solution containing 3.4 g of vinyl PDMS prepolymer+18 ul of a Pt catalyst (platinum divinyltetramethyldisiloxane)+one drop of modulator (2,4,6,8-tetramethyltetravinylcyclotetrasiloxane)+1 g of hydrosilane prepolymer can be mixed. Next, the PDMS solution can be spin coated on a master mold, and cured, for example, in a vacuum oven at 60° C. for 30 min. To form the second layer, a second PDMS solution can be mixed using the same PDMS solution as for the single PDMS layer. The second PDMS solution can be arranged on the on the first PDMS layer, and cured. For example, it can be cured, either in vacuum oven at 60° C. for 1 hr or in an ambient atmosphere for about 12 hours.

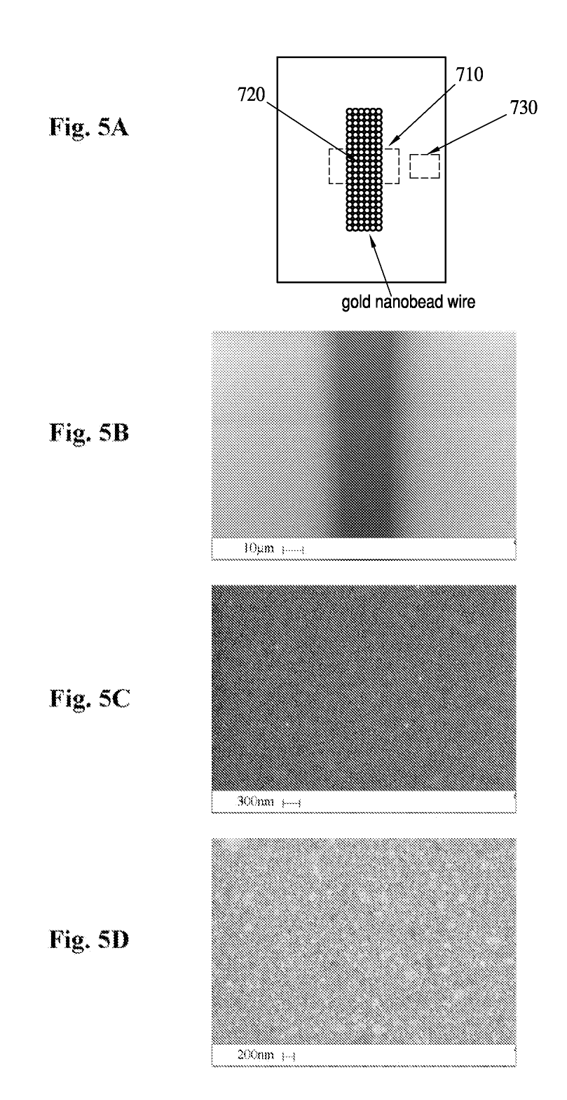

In the casting process, the PDMS solution was applied to the silicon substrate containing the mold for the template structure and allowed to cure. For example, cured in a vacuum oven at about 60° C. for 1 hr or in an ambient atmosphere for about 12 hours. The cured single-layer PDMS template was then separated from the master mold fabricated on a silicon substrate and was cut in a proper size for use as a reusable template structure. After completion of the PDMS template fabrication, the template was positioned on a gold film deposited on a silicon wafer. This film on the wafer served as the template channels' floor. A liquid suspension containing 30 nm gold nanobead suspended solution (e.g., gold nanocolloid solution) was then applied to the ends of the template structure while the template was on the substrate, and the solution was evaporated away using a 60° C. oven. The gold nanocolloid solution is commercially available from Ted Pella, Inc. After the solution had dried, the PDMS template was removed from the position, and the resulting nanowire formation is shown in FIG. 5. In particular, FIG. 5A illustrates a top view of a gold nanobead wire structure after the reusable template structure was removed, FIG. 5B is a FESEM image in area 710 of FIG. 5A, FIG. 5C is a FESEM image in area 720 of FIG. 5A showing 30 nm gold nanobeads, and FIG. 5D is a FESEM image in area 730 of FIG. 5A showing no gold nanobeads. The liquid can be removed leaving the nanoelements in place by drying techniques known in the art (e.g., evaporation). For example, these techniques may include evaporation under ambient conditions, reduced pressure, or over pressure, with or without external heating sources, etc. Also, such evaporation approaches could be replaced by electric field positioning, magnetic filed positioning or sonication or by some combination of all four.

### Example 2

### Formation of a Nano-Structure Through Electropolymerization

Polyaniline wires were grown on a silicon nitride coated silicon wafer using a steppable PDMS template and electropolymerization. The PDMS template plate, having three different channel widths (5 μm, 1 μm, and 0.5 μm), initially was positioned between two electrodes (anode and cathode) that were already formed on the substrate using dry etching, metal evaporation and lift-off. Three different widths (5 μm, 1 μm, and 0.5 μm) of nanowires were grown. These “step-and-grow” polyaniline nanowires showed conductivities of ˜10 S/cm.

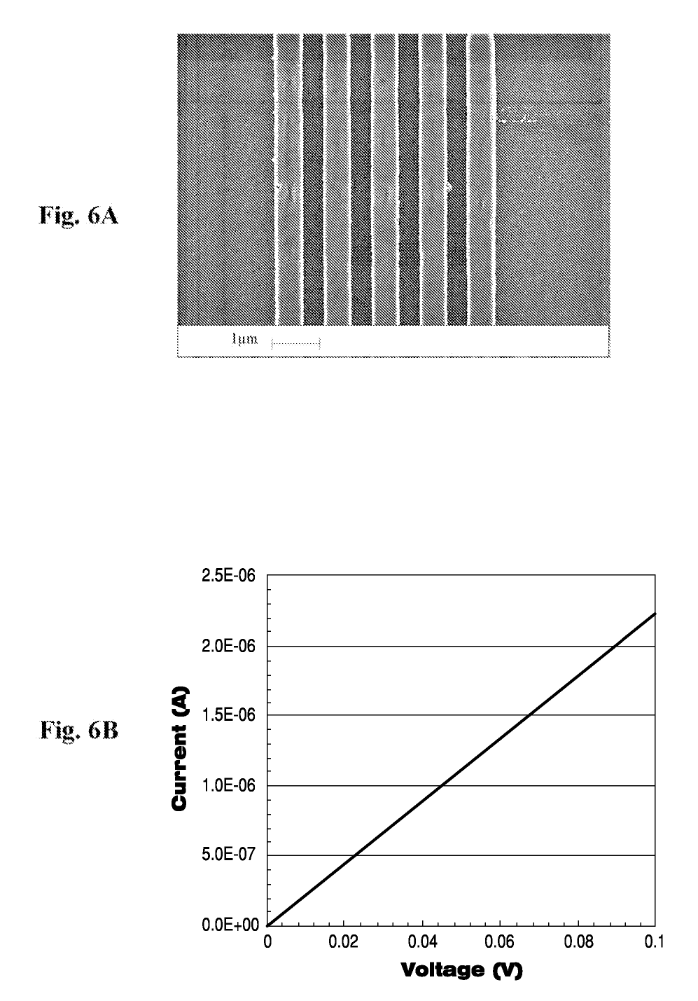

In the growth step, an aniline monomer dissolved in HCl solution, preferably about 0.3 M aniline in about 0.75 M HCl, was applied to the ends of the channels in the template. The monomer was introduced via capillary action into the channel structures formed by the template and the substrate top surface. Electropolymerization was then performed using the electrodes by applying about 1V of bias to the anode with the cathode grounded. The PDMS reusable template structure was removed after the polymerization process was completed, and stepped to the next electrode set for the next electropolymerization. Note that alignment is not a major issue since a transparent plate is being used as the template. The result of the polyaniline wire growth is shown in FIG. 6A, which shows a FESEM image of five polyaniline wires (500 nm wide, 200 nm high) connected in parallel to the electrodes. The picture was taken after removing the reusable template structure, and the result of the “step-and-grow” methodology is seen to be five 200 nm high wires. The quality of the electropolymerized polyaniline wire was established by measuring the electrical conductivity of the polymers using a HP4156 semiconductor parameter analyzer. FIG. 6B shows I-V characteristics of a single polyaniline wire (1 μm wide, 200 nm high and 10 μm long). The conductivity obtained by this measurement was 11 S/cm, and it is compatible with the values of polyaniline conductivity obtained for samples grown using other different techniques. (See C. Y. Peng, A. K. Kalkan, S. J. Fonash, B. Gu, and A. Sen, Nano Lett. 5, 439, (2005), M. Delvaux, J. Duchet, P. Y. Stavaux, R. Legras, S. Demoustier-Champagne, Synth. Met. 113, 275 (2000)).

### Example 3

### Growth of Nanowires Using an External Electrode Structure

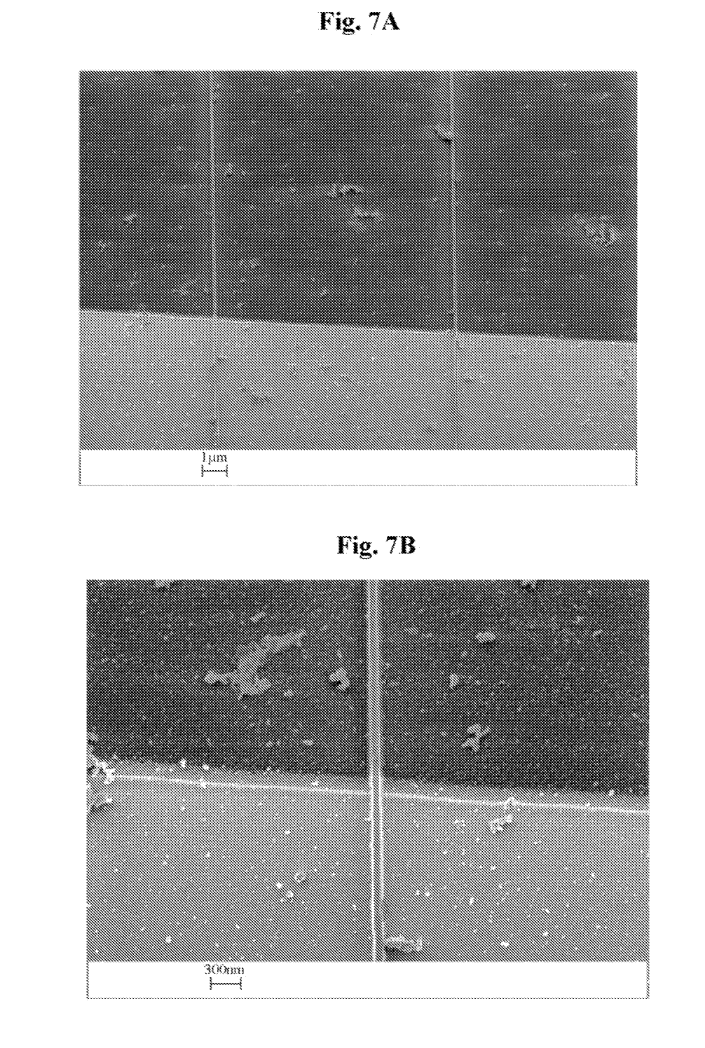

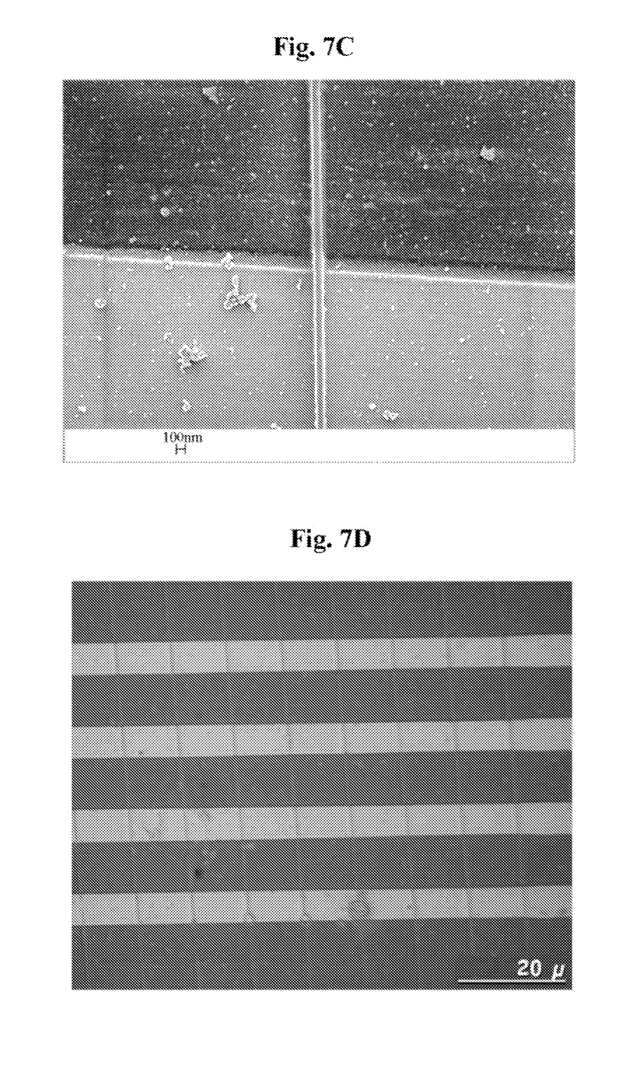

The configuration illustrated in FIG. 3A was used to grow tin nanowires. In particular, the reusable template structure was positioned on a substrate that had four electrode structures predisposed thereon. About 5 ul of commercially available Sn plating solution (purchased from Trensene, Inc.) was applied to the side of the reusable template structure. The electrode structure positioned on the substrate (i.e. electrode structure 310A) and the external electrode (i.e. electrode structure 310B) were connected to an HP4145 using two manipulator probes in an I-V station. In this exemplary demonstration, the external electrode was consumable (i.e., it was tin). A voltage of −0.075V was applied to the electrode structure positioned within the substrate, and a nanowire was grown for approximately 5 minutes. After the growing was complete, the electrical connections were disconnected and the reusable template structure was separated from the substrate. The surface of the substrate was then rinsed with isopropyl alcohol and deionized water, and subsequently dried. The resulting nano-structures are shown in FIGS. 7A-7D.

The claimed invention is:

1. A method of forming at least one nano-structure, comprising:
positioning a reusable template structure on a substrate, the reusable template structure including at least one nano-structure forming channel, the nano-structure forming channel being positioned in alignment with at least two electrode structures;
introducing at least one reagent into the channel; and
reacting the at least one reagent to form a nano-structure within the channel.

2. The method of claim 1, wherein at least one of the electrode structures is positioned within or upon the substrate.

3. The method of claim 1, wherein at least one of the electrode structures is embedded in the reusable template structure.

4. The method of claim 1, wherein at least one of the electrode structures is an external electrode structure positioned outside of the reusable template structure and independent of the substrate.

5. The method of claim 1, wherein at least one electrode structure is a source material for the formation of the nano-structure in the channel.

6. The method of claim 1, wherein the reagent comprises at least one of a polymerization monomer, organic molecule, metal catalyst, and an electrolyte.

7. The method of claim 6, wherein the reagent is an aniline monomer.

8. The method of claim 1, wherein the reacting step includes at least one of electrochemical reaction, electrodeposition, electroplating, and electropolymerization.

9. The method of claim 1, further comprising a step of introducing a catalyst into the channel prior to the step of introducing at least one reagent.

10. The method of claim 9, wherein the catalyst comprises one or more nanocolloid particles.

11. The method of claim 10, wherein the nanocolloids comprise metal nanocolloids.

12. The method of claim 1, further comprising repositioning the reusable template structure after the nano-structure is formed.

13. The method of claim 12, wherein the repositioning of the reusable template structure comprises stepping the reusable template structure to a different position on the substrate.

14. The method of claim 12, wherein the repositioning of the reusable template structure comprises stepping the reusable template structure to a new substrate.

15. The method of claim 9, wherein the reagent is SiH₄.

16. The method of claim 9, wherein the reacting step includes low-pressure chemical vapor deposition.

17. A method of forming at least one nano-structure, comprising:
positioning a reusable template structure on a substrate, the reusable template structure including at least one nano-structure forming channel;
introducing at least one reagent into the channel; and
forming a nano-structure within the channel.

18. The method of claim 17, wherein the reacting step includes low-pressure chemical vapor deposition.

19. The method of claim 17, wherein the reagent is SiH₄.

20. The method of claim 17, further comprising repositioning the reusable template structure after the nano-structure is formed.

21. The method of claim 20, wherein the repositioning of the reusable template structure comprises stepping the reusable template structure to a different position on the substrate.

22. The method of claim 20, wherein the repositioning of the reusable template structure comprises stepping the reusable template structure to a new substrate.
